(19) United States
(12) Patent Application Publication
(10) Pub. No.: US 2020/0154669 A1
(43) Pub. Date: May 21, 2020

(54) PET CUSHION

(71) Applicant: Li-Chen CHEN, Tainan City (TW)

(72) Inventor: Li-Chen CHEN, Tainan City (TW)

(21) Appl. No.: 16/373,634

(22) Filed: Apr. 3, 2019

(30) Foreign Application Priority Data
Nov. 19, 2018 (TW) 107215688

(51) Int. Cl. A01K 1/035; A01K 15/02

(52) U.S. Cl. CPC A01K 1/035; A01K 15/02

(57) ABSTRACT

A pet cushion includes a main body and a passage structure. The passage structure is connected to a surface of the main body, and includes at least two passage main bodies and at least one passage connecting portion. The at least one passage connecting portion is connected to an end of each of the at least two passage main bodies. A material of the at least one passage connecting portion is the same as a material of the at least two passage main bodies.

### RELATED APPLICATIONS

This application claims priority to Taiwan Application Serial Number 107215688, filed Nov. 19, 2018, which is herein incorporated by reference.

### BACKGROUND

### Technical Field

The present disclosure relates to a pet cushion. More particularly, the present disclosure relates to a pet cushion with a passage structure.

### Description of Related Art

Nowadays, dogs and cats are commonly kept as pets. The pets need a warm and soft cushion when they take a rest, and they also need a passage structure to exercise when they are energetic.

Generally speaking, the cushion and the passage structure are separate. Therefore, the cushion and the passage structure have to be bought respectively. Also, how to store the cushion and the passage structure is a problem. The cushion and the passage structure need to be stored, respectively. Furthermore, the passage structure is usually maintained the shape by an annular brace made of hard materials, such as a metal material or a plastic material. Hence, the passage structure only can be folded according to the shape of the annular brace and cannot be folded flexibly. It not only takes more space to store the cushion and the passage structure, but the passage structure is easily squeezed and deformed during storage.

### SUMMARY

According to one aspect of the present disclosure, a pet cushion includes a main body and a passage structure. The passage structure is connected to a surface of the main body, and includes at least two passage main bodies and at least one passage connecting portion. The at least one passage connecting portion is connected to an end of each of the at least two passage main bodies. A material of the at least one passage connecting portion is the same as a material of the at least two passage main bodies.

### BRIEF DESCRIPTION OF THE DRAWINGS

The present disclosure can be more fully understood by reading the following detailed description of the embodiment, with reference made to the accompanying drawings as follows:

FIG. 1 is an appearance schematic view of a pet cushion according to an embodiment of the present disclosure.

FIG. 2 is a partially cross-sectional view of the pet cushion according to the embodiment of FIG. 1.

FIG. 3 is an appearance schematic view of a pet cushion according to another embodiment of the present disclosure.

FIG. 4 is an appearance schematic view of a pet cushion according to still another embodiment of the present disclosure.

### DETAILED DESCRIPTION

The present disclosure can be more fully understood by reading the following detailed description of the embodiments, with reference made to the accompanying drawings as follows:

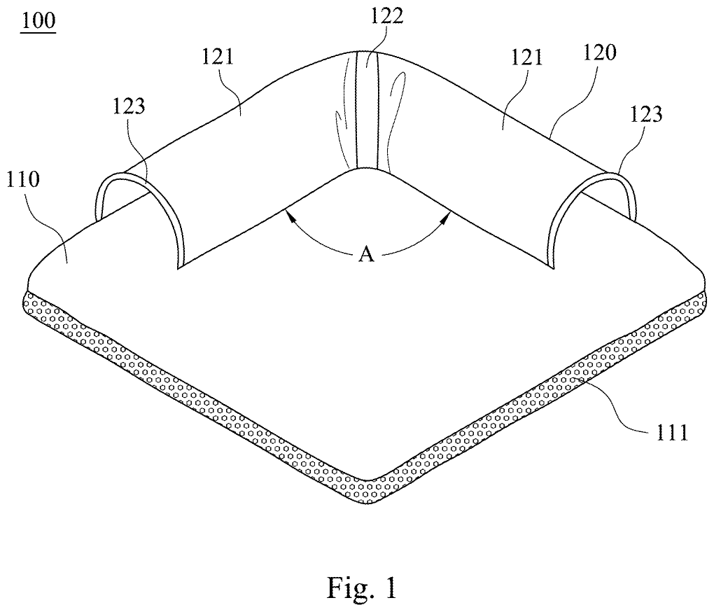

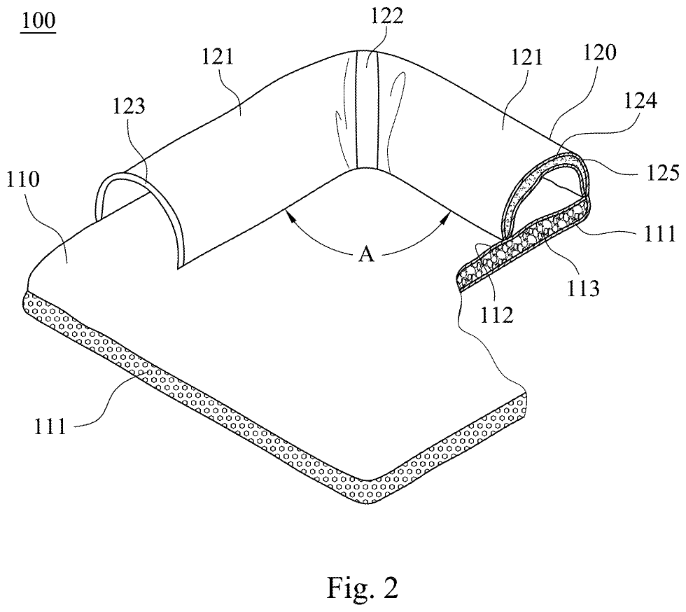

FIG. 1 shows an appearance schematic view of a pet cushion 100 according to an embodiment of the present disclosure, and FIG. 2 shows a partially cross-sectional view of the pet cushion 100 according to the embodiment of FIG. 1. In FIGS. 1 and 2, the pet cushion 100 includes a main body 110 and a passage structure 120. The passage structure 120 is connected to a surface of the main body 110. By the pet cushion 100, pets can be provided a place to take a rest and play at the same time, and the problem of storage can be solved.

In FIG. 1, the passage structure 120 includes at least two passage main bodies 121 and at least one passage portion 122. In the embodiment of FIG. 1, a number of the passage main bodies 121 is two, and a number of the passage connecting portion 122 is one. The passage connecting portion 122 is connected to an end of each of the passage main bodies 121. A material of the passage connecting portion 122 is the same as a material of the passage main bodies 121, and a shape of the passage main bodies 121 can be maintained by the connection between the passage connecting portion 122 and the passage main bodies 121. Therefore, the manufacturing convenience of the pet cushion 100 can be promoted. Also, because the material of the passage main bodies 121 and the material of the passage connecting portion 122 are the same, the pets will not feel uncomfortable during moving in the passage structure 120. In particularly, cats like narrow space. When the cats pass through the passage structure 120, they will feel surrounded, so that they feel secure. It is worth mentioning that the method of the passage connecting portion 122 connected to an end of each of the passage main bodies 121 can be sewing. The effect of supporting and fixing can be promoted by sewing.

In detail, each of the material of the passage main bodies 121 and the material of the passage connecting portion 122 can include a cloth material 124 and a packing material 125. The cloth material 124 is connected to the main body 110, and the packing material 125 is filled in the cloth material 124. Therefore, the comfort of the pets passing through the passage structure 120 can be promoted by the feeling of the cloth material 124. Also, by filling the packing material 125 in the cloth material 124, the pets feel warm and comfortable when they take a rest, and the passage structure 120 can be maintained a fixed shape that is not deformed by folding.

The main body 110 can include a cloth material 112 and a packing material 113. The packing material 113 of the main body 110 is filled in the cloth material 112 of the main body 110. Therefore, the comfortable feeling can be provided by the cloth material 112, and the soft space provided the pets with rest by the packing material 113. Furthermore, the cloth material 124 of the passage main bodies 121 and the passage connecting portion 122 is connected to the cloth material 112 of the main body 110, and the cloth material 124 is different from the cloth material 112. Therefore, the main body 110 of the pet cushion 100 is differentiated from the passage structure 120 of the pet cushion 100 by the different cloth materials to sort the space of rest and play.

In detail, the cloth material 112 of the main body 110 can be a cotton cloth material or a polyester material, and the packing material 113 of the main body 110 can be a cotton material or a latex packing material. The cloth material 124 of the passage main bodies 121 and the passage connecting portion 122 can be the cotton cloth material or the polyester material, and the packing material 125 of the passage main bodies 121 and the passage connecting portion 122 can be the cotton material or the latex packing material. But the present disclosure is not limited thereto.

Furthermore, the pet cushion 100 can further include a skidproof structure 111. By the skidproof structure 111, the slip condition of the pet cushion 100 can be reduced during the pets passing through the passage structure 120, and the possibility of the pets being injured by the pet cushion 100 slipped can be lowered.

The passage structure 120 can further include at least two supporting portions 123 connected to another end of the at least two passage main bodies 121, respectively. In detail, a number of the supporting portions 123 is two in the embodiment of FIG. 1. By the passage connecting portion 122 of the passage structure 120 and the supporting portions 123 of the passage structure 120, the supporting capability of the passage structure 120 can be provided to make the pets to flexibly pass through the passage structure 120. Compared to the support with hard materials (such as a metal material or a plastic material), because the cloth material 124 and the packing material 125 are used to be the material of the passage connecting portion 122 and the supporting portions 123, the pets will feel more comfortable when passing through the passage structure 120, and the pet cushion 100 can be flexibly folded to be easily stored.

Furthermore, an angle A is formed between the passage main bodies 121. In detail, by the connection of the connecting portion 122, the angle A can be formed between the passage main bodies 121 and disposed according to a shape of the main body 110. In the embodiment of FIG. 1, the angle A between the passage main bodies 121 is 90° according to the rectangle shape of the main body 110, but the present disclosure is not limited thereto. The angle of the angle A between the passage main bodies 121 can be decided according to the shape of the main body 110 during the manufacturing process.

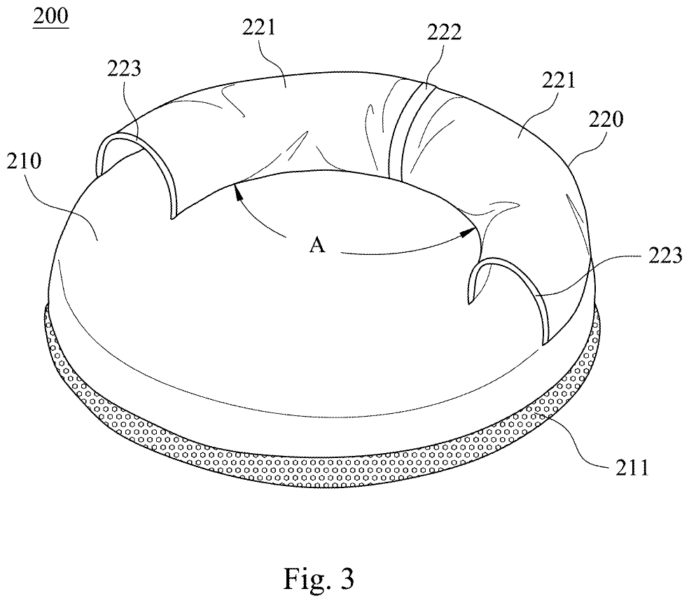

FIG. 3 shows an appearance schematic view of a pet cushion 200 according to another embodiment of the present disclosure. In FIG. 3, the pet cushion 200 includes a main body 210 and a passage structure 220. The passage structure 220 is connected to a surface of the main body 210. By the pet cushion 200, the pets can be provided a place to take a rest and play at the same time, and the problem of storage can be solved.

In FIG. 3, the passage structure 220 includes at least two passage main bodies 221 and at least one passage connecting portion 222. In detail, a number of the passage main bodies 221 is two, and a number of the passage connecting portion 222 is one. The passage connection portion 222 is connected to an end of each of the passage main bodies 221. A material of the passage connecting portion 222 is the same as a material of the passage main bodies 221. Therefore, the manufacturing convenience of the pet cushion 200 can be promoted. Also, because the material of the passage main bodies 221 and the material of the passage connecting portion 222 are the same, the pets will not feel uncomfortable during moving in the passage structure 220. In particularly, the cats like narrow space. When the cats pass through the passage structure 220, they will feel surrounded, so that they feel secure.

Furthermore, each of the material of the passage main bodies 221 and the material of the passage connecting portion 222 can further include a cloth material (its reference numeral is omitted) and a packing material (its reference numeral is omitted). The cloth material and the packing material are the same as the cloth material 124 and the packing material 125 of the embodiment of FIGS. 1 and 2, and will not be described again herein.

The main body 210 can include a cloth material (its reference numeral is omitted) and a packing material (its reference numeral is omitted), the cloth material and the packing material can be the same as the cloth material 112 and the packing material 113 of the embodiment of FIGS. 1 and 2, and will not be described again herein. Furthermore, the cloth material of the passage main bodies 221 and the passage connecting portion 222 is connected to the cloth material of the main body 210, and the cloth material of the passage main bodies 221 and the passage connecting portion 222 can be different from the cloth material of the main body 210. Therefore, the main body 210 of the pet cushion 200 is differentiated from the passage structure 220 of the pet cushion 200 by the different cloth materials to sort the space of rest and play.

In the embodiment of FIG. 3, the pet cushion 200 can include a skidproof structure 211. By the skidproof structure 211, the slip condition of the pet cushion 200 can be reduced during the pets passing through the passage structure 220, and the possibility of the pets being injured by the pet cushion 200 slipped can be lowered.

In FIG. 3, an angle A is formed between the passage main bodies 221 of the pet cushion 200, and the angle A can be disposed according to a shape of the main body 210. In detail, the shape of the main body 210 is round in the embodiment of FIG. 3, and the angle of the angle A between the passage main bodies 221 can be adjusted according to the circular main body 210 by the connection of the passage connecting portion 222.

Moreover, the passage structure 220 can further include at least two supporting portions 223 connected to another end of the at least two passage main bodies 221, respectively. In detail, a number of the supporting portions 223 is two in the embodiment of FIG. 3. By the passage connecting portion 222 of the passage structure 220 and the supporting portions 223 of the passage structure 220, the supporting capability of the passage structure 220 can be provided to make the pets to flexibly pass through the passage structure 220. Compared to the support with hard materials (such as the metal material or the plastic material), because the cloth material (its reference numeral is omitted) and the packing material (its reference numeral is omitted) are used to be the material of the passage connecting portion 222 and the supporting portions 223, the pets will feel more comfortable when passing through the passage structure 220, and the pet cushion 200 can be freely folded to be easily stored.

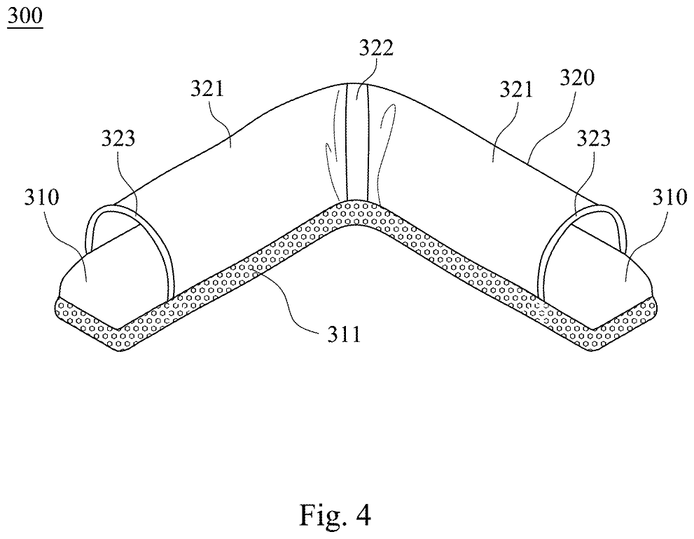

FIG. 4 shows an appearance schematic view of a pet cushion 300 according to still another embodiment of the present disclosure. In FIG. 4, the pet cushion 300 includes a main body 310 and a passage structure 320. The passage structure 320 is connected to a surface of the main body 310. The passage structure 320 includes at least two passage main bodies 321 and at least one passage connecting portion 322. In the embodiment of FIG. 4, a number of the passage main bodies 321 is two, and a number of the passage connecting portion 322 is one. The passage connecting portion 322 is connected to an end of each of the passage main bodies 321. A material of the passage connecting portion 322 is the same as a material of the passage main bodies 321. The passage structure 320 can further include at least two supporting portions 323 connected to another end of the at least two passage main bodies 321, respectively. In the embodiment of FIG. 4, a number of the supporting portions 323 is two. The part of embodiment of FIG. 4 is the same as FIGS. 1, 2 and 3, and will not be described again herein.

Moreover, the pet cushion can include a skidproof structure 311. The main body 310 can include a cloth material (its reference numeral is omitted) and a packing material (its reference numeral is omitted). The cloth material and the packing material can be the same as the cloth material 112 and the packing material 113 of the embodiment of FIGS. 1, 2 and 3, and will not be described again herein. The cloth material of the passage main body 321 and the passage connecting portion 322 is connected to the cloth material of the main body 310, and the cloth material of the passage main bodies 321 and the passage connecting portion 322 can be different from the cloth material of the main body 310.

Furthermore, a range of an area of the main body 310 of the pet cushion 300 is similar to a range of an area of the passage structure 320 covered, and the range of the main body 310 is slightly over two sides of the passage structure 320. The area of the main body 310 over the passage structure 320 can be used for the pets resting.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A pet cushion, comprising:
a main body; and
a passage structure connected to a surface of the main body, and comprising:
at least two passage main bodies; and
at least one passage connecting portion connected to an end of each of the at least two passage main bodies, wherein a material of the at least one passage connecting portion is the same as a material of the at least two passage main bodies.

2. The pet cushion of claim 1, wherein each of the material of each of the passage main bodies and the material of the passage connecting portion comprises a cloth material, and the cloth material is connected to the main body.

3. The pet cushion of claim 2, wherein each of the material of each of the passage main bodies and the material of the passage connecting portion further comprises a packing material, and the packing material is filled in the cloth material.

4. The pet cushion of claim 1, wherein the passage structure further comprises:
at least two supporting portions connected to another end of the at least two passage main bodies, respectively.

5. The pet cushion of claim 2, wherein the main body comprises a cloth material.

6. The pet cushion of claim 5, wherein the cloth material of the main body is different from the cloth material of each of the passage main bodies and the cloth material of the passage connecting portion.

7. The pet cushion of claim 5, wherein the main body further comprises a packing material filled in the cloth material of the main body.

8. The pet cushion of claim 1, further comprising:
a skidproof structure connected to another surface of the main body.

9. The pet cushion of claim 1, wherein an angle is formed between the at least two passage main bodies.

10. The pet cushion of claim 1, wherein a shape of the main body is rectangular or round.
